(19) United States
(12) Patent Application Publication
(10) Pub. No.: US 2014/0093920 A1
(43) Pub. Date: Apr. 3, 2014

(54) METHODS FOR TREATING LIGNOCELLULOSIC MATERIALS

(71) Applicants: Queensland University of Technology, Brisbane (AU); Syngenta Participations AG, Basel (SE)

(72) Inventors: Zhanying Zhang, Carina (AU); Ian Mark O'Hara, Grange (AU); William Orlando Sinclair Doherty, Calamvale (AU)

(73) Assignees: Queensland University of Technology, Brisban (AU); Syngenta Participations AG, Basel (SE)

(21) Appl. No.: 14/100,486

(22) Filed: Dec. 9, 2013

Related U.S. Application Data
(63) Continuation of application No. PCT/EP2012/060865, filed on Jun. 8, 2012.
(60) Provisional application No. 61/570,444, filed on Dec. 14, 2011.
(60) Provisional application No. 61/495,549, filed on Jun. 10, 2011.

(51) Int. Cl. C13K 1/02

(52) U.S. Cl. CPC C13K 1/02
USPC 435/105; 127/37

(57) ABSTRACT

The present invention provides compositions and methods for the pretreatment of lignocellulosic material. The present invention further provides for pretreated lignocellulosic material that can be used to produce products, such as fermentable sugars.

### RELATED APPLICATIONS

This application claims the benefit of and priority from U.S. Provisional Application No. 61/570,444, filed on Dec. 14, 2011 and U.S. Provisional Application No. 61/495,549, filed on Jun. 10, 2011, the disclosures of each of which are incorporated herein by reference in their entirety.

### FIELD OF THE INVENTION

The present invention concerns pretreatment solutions for lignocellulosic material and methods for pretreating lignocellulosic material that can be used to produce products, such as fermentable sugars.

### BACKGROUND OF THE INVENTION

Lignocellulosic material can be used to produce biofuels (e.g., bioethanol) and biochemicals, and thus is an alternative to fossil fuels. For efficient biofuel production from lignocellulosic materials, the cellulose and/or hemicellulose components of lignocellulosic material need to be converted to monosaccharides (i.e., monosugars) that are capable of being fermented into ethanol or butanol. Prior work in this area has proposed processes for the production of fermentable sugars from lignocellulosic material that involve a chemical and/or physical pretreatment to disrupt the natural structure of the lignocellulosic material, followed by enzymatic hydrolysis of the cellulose and hemicellulose components into monosugars. The monosugars can then be fermented to produce biofuels including ethanol or butanol, and/or other fermentation products such as organic acids and/or other alcohols. However, these processes currently have not been commercialized due to the high cost, low efficiency, adverse reaction conditions, and other issues associated with the pretreatment process. In addition, these processes are not environmentally friendly and in order to achieve effective and efficient hydrolysis, a large addition of enzymes is required, which further increases costs.

The present invention addresses previous shortcomings in the art by providing pretreatment solutions for lignocellulosic material and methods for pretreating lignocellulosic material that can be used to produce fermentable sugars.

### SUMMARY OF THE INVENTION

A first aspect of the present invention is a method for producing a partially hydrolyzed lignocellulosic material, comprising pretreating a lignocellulosic material with a pretreatment solution comprising about 40% to about 95% by weight an ionic liquid, about 0.1% to about 5.0% by weight an acid catalyst, and about 5% to about 60% by weight water, thereby producing a pretreated partially hydrolyzed lignocellulosic material.

A further aspect of the present invention is a method for producing a fermentable sugar, comprising pretreating a lignocellulosic material with a pretreatment solution comprising about 40% to about 95% by weight an ionic liquid and about 5% to about 60% by weight water to produce a pretreated lignocellulosic material, and enzymatically hydrolyzing the pretreated lignocellulosic material, thereby producing a fermentable sugar.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

FIG. 1 shows FUR spectra of (a) untreated bagasse, (b) bagasse pretreated with an HCl solution, and (c) bagasse pretreated with a 1-n-butyl-3-methylimidazolium chloride (BMIMCl)/HCl/water solution.

FIG. 2 shows SEM images of (a) untreated bagasse, (b) bagasse pretreated with an HCl solution, and (c) bagasse pretreated with a BMIMCl/HCl/water solution. Samples were magnified 1000 times.

FIG. 3 shows glucan content (%) of sugar cane bagasse pretreated at 130° C. for 2 hours.

FIG. 4 shows glucose yield (%) of pretreated sugar cane bagasse after enzymatic hydrolysis; open square and open diamond symbols correspond to bagasse pretreated with a pretreatment solution comprising 6% FeCl₃ (based on the weight of the dry bagasse), filled in symbols correspond to bagasse pretreated with a pretreatment solution comprising 18% FeCl₃ (based on the weight of the dry bagasse).

FIG. 5 shows glucose yield (%) of pretreated sugar cane bagasse after enzymatic hydrolysis; open triangle and open diamond symbols correspond to bagasse pretreated with a pretreatment solution comprising 6% FeCl₃ (based on the weight of the dry bagasse), filled in symbols correspond to bagasse pretreated with a pretreatment solution comprising 0.18% FeCl₃ (based on the weight of the dry bagasse).

### DETAILED DESCRIPTION OF THE INVENTION

The terminology used in the description of the invention herein is for the purpose of describing particular embodiments only and is not intended to be limiting of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety.

As used in the description of the invention and the appended claims, the singular forms “a”, “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination.

Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP §2111.03. Thus, the term “consisting essentially of” as used herein should not be interpreted as equivalent to “comprising.”

The term “about,” as used herein when referring to a measurable value such as an amount or concentration (e.g., the amount of an ionic liquid in the pretreatment solution) and the like, is meant to encompass variations of 20%, 10%, 5%, 1%, 0.5%, or even 0.1% of the specified amount.

The present invention relates to pretreatment solutions for lignocellulosic material and methods for hydrolyzing lignocellulosic material that can subsequently be used to produce fermentable sugars.

“Lignocellulosic” or “lignocellulose”, as used herein, refer to material comprising lignin and/or cellulose. Lignocellulosic material can also comprise hemicellulose, xylan, proteins, lipids, carbohydrates, such as starches and/or sugars, or any combination thereof. Lignocellulosic material can be derived from living or previously living plant material (e.g., lignocellulosic biomass). “Biomass,” as used herein, refers to any lignocellulosic material and can be used as an energy source.

Lignocellulosic material (e.g., lignocellulosic biomass) can be derived from a single material or a combination of materials and/or can be non-modified and/or modified. Lignocellulosic material can be transgenic (i.e., genetically modified). “Transgenic”, as used herein, refers to a plant into which a transgene has been delivered or introduced and the transgene can be expressed in the transgenic plant to produce a product, the presence of which can impart an effect and/or a phenotype in the plant. The term “transgene” as used herein, refers to any nucleic acid sequence used in the transformation of a plant. Thus, a transgene can be a coding sequence, a non-coding sequence, a cDNA, a gene or fragment or portion thereof, a genomic sequence, a regulatory element and the like. In some embodiments of the present invention, the lignocellulosic material is a transgenic plant or transgenic plant material that expresses or expressed exogenous enzymes.

Lignocellulose is generally found, for example, in the fibers, pulp, stems, leaves, hulls, canes, husks, and/or cobs of plants or fibers, leaves, branches, bark, and/or wood of trees and/or bushes. Exemplary lignocellulosic materials include, but are not limited to, agricultural biomass, e.g., farming and/or forestry material and/or residues, branches, bushes, canes, forests, grains, grasses, short rotation woody crops, herbaceous crops, and/or leaves; energy crops, e.g., corn, millet, and/or soybeans; energy crop residues; paper mill residues; sawmill residues; municipal paper waste; orchard prunings; chaparral; wood waste; logging waste; forest thinning; short-rotation woody crops; bagasse, such as sugar cane bagasse and/or sorghum bagasse, duckweed; wheat straw; oat straw; rice straw; barley straw; rye straw; flax straw; soy hulls; rice hulls; rice straw; tobacco; corn gluten feed; oat hulls; corn kernel; fiber from kernels; corn stover; corn stalks; corn cobs; corn husks; canola; miscanthus; energy cane; prairie grass; gamagrass; foxtail; sugar beet pulp; citrus fruit pulp; seed hulls; lawn clippings; cotton, seaweed; trees; shrubs; wheat; Wheat straw; products and/or by-products from wet or dry milling of grains; yard waste; plant and/or tree waste products; herbaceous material and/or crops; forests; fruits; flowers; needles; logs; roots; saplings; shrubs; switch grasses; vegetables; fruit peels; vines; wheat midlings; oat hulls; hard and soft woods; or any combination thereof. In some embodiments, the lignocellulosic material has been processed by a processor selected from the group consisting of a dry grind ethanol production facility, a paper pulping facility, a tree harvesting operation, a sugar cane factory, or any combination thereof. In other embodiments of this invention, the lignocellulosic material is bagasse.

The methods of the present invention can comprise, consist essentially of, or consist of pretreating the lignocellulosic material (e.g., biomass) with a pretreatment solution of the present invention. “Pretreating”, “pretreatment” and any grammatical variants thereof, as used herein refers to treating, contacting, soaking, suspending, immersing, saturating, dipping, wetting, rinsing, washing, submerging, and/or any variation and/or combination thereof, the lignocellulosic material with a pretreatment solution of the present invention. In certain embodiments of the present invention, pretreating the lignocellulosic material with a pretreatment solution of the present invention causes the lignocellulosic material to swell.

The pretreating step can be performed or carried out at a temperature from about 40° C. to about 150° C. or any range therein, such as, but not limited to, about 40° C. to about 90° C., about 80° C. to about 150° C., about 90° C. to about 130° C., or about 100° C. to about 130° C. In particular embodiments, the pretreatment step is carried out at a temperature of about 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 7.9° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., or any range therein. In some embodiments of the present invention, the pretreatment step is carried out at a temperature of about 130° C. In other embodiments of the present invention, the pretreatment step is carried out at a temperature from about 40° C. to about 90° C.

The pretreating step can be performed or carried out for a period of time from about 1 minute to about 24 hours or any range therein, such as, but not limited to, about 1 hour to about 6 hours, about 1 minute to about 120 minutes, about 5 minutes to about 60 minutes, or about 15 minutes to about 30 minutes. In particular embodiments, the pretreatment step is carried out for a period of time of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120 minutes, or 1, 2, 3, 4, 5, 6, 7, 8, 9, 10, 11, 12, 13, 14, 15, 16, 17, 18, 19, 20, 21, 22, 23, 24 hours, or any range therein. In certain embodiments of the present invention, the pretreatment step is carried out for a period of time of about 30 minutes.

Lignocellulosic biomass loading (i.e. the lignocellulosic material to pretreatment solution ratio) can be from about 0.1% to about 60% by weight of the pretreatment solution or any range therein, such as, but not limited to, about 5% to about 40% or about 5% to about 20% by weight of the pretreatment solution. In particular embodiments, the lignocellulosic biomass loading is about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, or any range therein, by weight of the pretreatment solution. In certain embodiments of the present invention, the lignocellulosic biomass loading is about 10% by weight of the pretreatment solution.

A pretreatment solution of the present invention can comprise, consist essentially of, or consist of an ionic liquid, an acid catalyst, water, or any combination thereof. According to some embodiments of the present invention, the pretreatment solution comprises, consists essentially of; or consists of an ionic liquid and water.

“Ionic liquid”, as used herein, refers to a substance composed only of ions that remains in a liquid state below the boiling point of water and/or in a liquid state at room temperature. Ionic liquids are low melting point (generally less than about 100° C.) compounds composed of a cation and an anion. Ionic liquids can have a very low or no measurable vapor pressure, can solvate a wide variety of compounds, and are thermally, electrically, and chemically stable. A delocalization of charge on the anion in an ionic liquid limits its ability to form a crystal lattice, resulting in a low melting point. At room temperature, the ions (i.e., cation and anion) in an ionic liquid are organized in a less compact manner and are free to interact with any solutes present. Ionic liquids can thus replace water and other solvents in many applications.

An ionic liquid can be an organic salt, which comprises an organic ion. An organic salt is larger and more complex than common salts, such as sodium chloride. Exemplary organic salts include, but are not limited to, carboxylates, such as formate, lactate, acetate, propanoate and benzoate, and sulphonates, such as mesylate, triflate, tosylate, and besylate.

The anion and cation choice of an ionic liquid can be tailored to provide desired solvent characteristics, such as polarity, viscosity, hydrogen bonding capacity, miscibility, and conductivity. Ionic liquid properties (polarity, miscibility, hydrophobicity, etc.) can be tailored by varying the properties of the cation and anion, such as, but not limited to, varying the side chain length of the cation and/or anion. In some embodiments of the present invention, the ionic liquid can be tailored to interfere positively with hydrogen bonding as well as electrostatic and hydrophobic interactions that govern protein function.

Exemplary cations that can be used in ionic liquids include, but are not limited to, imidazolium cations, pyridinium cations, phosphonium cations, ammonium cations, pyrrolidinium cations, guanidinium cations, isouronium cations, hydrocarbylammonium cations, hydrocarbylphosphonium cations, hydrocarbylpyridinium cations, dihydrocarbylimidazolium cations, and any combination thereof. Exemplary anions that can be used in ionic liquids include, but are not limited to, halide anions such as chloride, bromide, fluoride, and iodide anions, acetate anions, sulfate anions, sulfonate anions, amide anions, imide anions, borate anions, phosphate anions, chlorometalate anions, fluoroborate anions such as tetrafluoroborate anions and hydrocarbyl substituted fluoroborate anions, fluorophosphate anions such as hexafluorophosphate anions and hydrocarbyl substituted fluorophosphate anions, and any combination thereof. In some embodiments of the present invention, the cation in an ionic liquid is an imidazolium cation. In other embodiments of the present invention, the anion in an ionic liquid is a halide anion and/or an acetate anion.

Non-limiting examples of ionic liquids include 1-allyl-3-methylimidazolium chloride (AMIMCl), 1-butyl-3-methylimidazolium chloride (BMIMCl), 1-butyl-3-methylimidazolium methylsulfate (BMIMCH₃SO₄), 1-butyl-3-methylimidazolium ethylsulfate (BMIMEtOSO₃), 1-butyl-3-methylimidazolium hydrogensulfate (BMIMHSO4), 1-butyl-3-methylimidazolium methanesulfonate (BMIMCH₃SO₃), 1-butyl-3-methylimidazolium tosylate (BMIMTos), 1-butyl-3-methylimidazolium hexafluorophosphate, 1-ethyl-3-methylimidazolium chloride (EMIMCl), 1-ethyl-3-methylimidazolium ethylsulfate (EMIMMEtSO₃), 1-ethyl-3-methylimidazolium methanesulfonate (EMIMCH₃SO₃), 1-ethyl-3-methylimidazolium tosylate (EMIMTos), 1-ethyl-3-methylimidazolium chloride-aluminium (III) chloride, 1,3-dimethylimidazolium dimethylphosphate, N-butyl pyridinium chloride aluminium (III) chloride, ethylammonium nitrate (EAN), dimethylammonium hydrogen sulfate (DMAHSO₄), dimethylammonium triflate (TEATf), triethylammonium methane sulfonate (TEAMs), trimethylphenyl ammonium, chloroaluminate (TMPACA), benzyltrimethyl ammonium chloroaluminate (BTMACA), benzyltriethyl ammonium chloroaluminate (BTEACA), benzyltributyl ammonium chloroaluminate (“BTBACA”), trimethylphenyl phosphonium Chloroaluminate (TMPPCA), benzyltrimethyl phosphonium chloroaluminate (“BTMPCA”), benzyltriethyl phosphonium chloroaluminate (BTEPCA), benzyltributyl phosphonium chloroaluminate (BTBPCA), 1-butyl-4-methyl-pyridinium chloroaluminate (BMPYCA), 1-butyl-pyridinium chloroaluminate (BPYCA), 3-methyl-1-propyl-pyridinium chloroaluminate (MPPYCA), 1-butyl-3-methyl-imidozolium chloroaluminate (BMIMCA), 1-ethyl-3-methyl-imidazolium chloroaluminate (EMIMCA), 1-ethyl-3-methyl-imidazolium bromo-trichloroaluminate (EMIMBTCA), 1-hexyl-3-methyl-imidazolium chloroaluminate (HMIMCA), benzyltrimethyl ammonium chlorotrimethylaluminate (BTMACTMA), 1-methyl-3-octyl-imidazolium chloroaluminate (MOIMCA), trimethylphenyl ammonium fluoroborate (TMPAFB), benzyltrimethyl ammonium fluoroborate (BTMAFB), benzyltriethyl ammonium fluoroborate (BTEAFB), benzyltributyl ammonium fluoroborate (BTBAFB), trimethylphenyl phosphonium fluoroborate (TMPPFB), benzyltrimethyl phosphonium fluoroborate (BTMPFB), benzyltriethyl phosphonium fluoroborate (BTEPFB), benzyltributyl phosphonium fluoroborate (BTBPFB), 1-butyl-4-methyl-pyridinium fluoroborate (BMPFB), 1-butyl-pyridinium fluoroborate (BPFB), 3-methyl-1-propyl-pyridinium fluoroborate (MPPFB), 1-butyl-3-methyl-imidazolium fluoroborate (BMIMFB), 1-ethyl-3-methyl-imidazolium fluoroborate (EMIMFB), 1-ethyl-3-methyl-imidazolium bromo-trifluoroborate (EMIMBTFB), 1-hexyl-3-methyl-imidazolium fluoroborate (HMIMFB), 1-methyl-3-octyl-imidazolium fluoroborate (MOIMFB), benzyltrimethyl ammonium fluorophosphate (BTMAFP), and any combination thereof.

One or more ionic liquids can be present in the pretreatment solutions of the present invention. For example, 1, 2, 3, 4, 5, or more ionic liquids can be present in the pretreatment solutions of the present invention. In certain embodiments of the present invention, the ionic liquid can have a strong acidic anion, such as but not limited to 1-butyl-3-methylimidazolium methanesulfonate (BMIMCH₃SO₃), 1-butyl-3-methylimidazolium tosylate (BMIMTos), 1-ethyl-3-methylimidazolium methanesulfonate (EMIMCH₃SO₃), and 1-ethyl-3-methylimidazolium tosylate (EMIMTos). The ionic liquid, in some embodiments, can have a pH of less than about pH 2 in an aqueous solution. In some embodiments of the present invention, the ionic liquid is 1-n-butyl-3-methylimidazolium chloride (BMIMCl).

The one or more ionic liquid(s) can be present in the pretreatment solution in an amount from about 5% to about 99% by weight of the pretreatment solution or any range therein, such as, but not limited to, about 20% to about 99%, about 40% to about 99%, or about 70% to about 90% by weight of the pretreatment solution. In particular embodiments of the present invention, the ionic liquid(s) is present in the pretreatment solution in an amount of about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or any range therein, by weight of the pretreatment solution. In certain embodiments of the present invention, the ionic liquid(s) is present in an amount from about 70% to about 85% by weight of the pretreatment solution.

One or more acid catalysts can be present in the pretreatment solutions of the present invention. For example, 1, 2, 3, 4, 5, or more acid catalyst(s) can be present in the pretreatment solutions of the present invention. In some embodiments of the present invention, one acid catalyst is utilized. The acid catalyst(s) can be present in the pretreatment solution in an amount from about 0.01% to about 10.0% by weight of the pretreatment solution or any range therein, such as, but not limited to, about 0.1% to about 5% or about 1% to about 3.0% by weight of the pretreatment solution. In particular embodiments of the present invention, the acid catalyst(s) is present in the pretreatment solution in an amount of about 0.01%, 0.025%, 0.05%, 0.075%, 0.1%, 0.25%, 0.5%, 0.75%, 1%, 1.2%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, or any range therein, by weight of the pretreatment solution. In certain embodiments of the present invention, the acid catalyst(s) is present in an amount from about 0.5% to about 2% by weight of the pretreatment solution.

The amount of the acid catalyst in the pretreatment solution can also be calculated based on the dry weight of the lignocellulosic material. The acid catalyst(s) can be present in the pretreatment solution in an amount from about 1% to about 25% by weight of the dry lignocellulosic material, or any range therein, such as, but not limited to, about 2% to about 20% or about 5% to about 20% by weight of the dry lignocellulosic material. In particular embodiments of the present invention, the acid catalyst(s) is present in the pretreatment solution in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or any range therein, by weight of the dry lignocellulosic material.

“Acid catalyst”, as used herein refers to various water-soluble compounds with a pH of less than 7 that can be reacted with a base to form a salt. Exemplary acid catalysts can be monoprotic or polyprotic and can comprise one, two, three, or more acid functional groups. Exemplary acid catalysts include, but are not limited to mineral acids, Lewis acids, acidic metal salts, organic acids, solid acids, inorganic acids, or any combination thereof. Specific acid catalysts include, but are not limited to hydrochloric acid, sulfuric acid, phosphoric acid, hydrofluoric acid, hydrobromic acid, hydroiodic acid, nitric acid, formic acid, acetic acid, methanesulfonic acid, toluenesulfonic acid, boron trifluoride diethyletherate, scandium (III) trifluoromethanesulfonate, titanium (IV) isopropoxide, tin (IV) chloride, zinc (II) bromide, iron (II) chloride, iron (III) chloride, zinc (H) chloride, copper (I) chloride, copper (I) bromide, copper (II) chloride, copper (II) bromide, aluminum chloride, chromium (II) chloride, chromium (III) chloride, vanadium (III) chloride, molybdenum (II) chloride, palladium (II) chloride, platinum (II) chloride, platinum (IV) chloride, ruthenium (III) chloride, rhodium (III) chloride, zeolites, activated zeolites, or any combination thereof. In certain embodiments, the acid catalyst is hydrochloric acid.

Water can be present in the pretreatment solution in an amount from about 1% to about 80% by weight of the pretreatment solution, or any range therein, such as, but not limited to, about 1% to about 60% or about 5% to about 30% by weight of the pretreatment solution. In particular embodiments of the present invention, water is present in the pretreatment solution in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, or any range therein, by weight of the pretreatment solution. In certain embodiments, water is present in an amount from about 15% to about 25% by weight of the pretreatment solution.

In some embodiments of the present invention, the pretreatment solution comprises, consists essentially of, or consists of an ionic liquid and an acid catalyst. In other embodiments of the present invention, the pretreatment solution comprises, consists essentially of, or consists of an ionic liquid, an acid catalyst, and water.

According to some embodiments of the present invention, the pretreatment solution comprises, consists essentially of, or consists of about 40% to about 99% by weight an ionic liquid and about 1% to about 60% by weight water. In certain embodiments of the present invention, the pretreatment solution comprises, consists essentially of, or consists of about 70% to about 85% by weight an ionic liquid and about 10% to about 30% by weight water.

In particular embodiments of the present invention, the pretreatment solution comprises, consists essentially of, or consists of about 40% to about 95% by weight an ionic liquid, about 0.1% to about 5% by weight an acid catalyst, and about 5% to about 60% by weight water. In some embodiments of the present invention, the pretreatment solution comprises, consists essentially of, or consists of about 70% to about 85% by weight an ionic liquid, about 0.5% to about 2% by weight an acid catalyst, and about 10% to about 30% by weight water. In other embodiments of the present invention, the pretreatment solution comprises, consists essentially of, or consists of about 78.8% by weight an ionic liquid, about 1.2% by weight an acid catalyst, and about 20% by weight water.

The pretreatment step can result in the hydrolysis and/or break down of the lignocellulosic material. “Hydrolysis”, as used herein, refers to the cleavage or breakage of the chemical bonds that hold the lignocellulosic material together. For instance, hydrolysis can include, but is not limited to, the breaking or cleaving of glycosidic bonds that link saccharides (i.e., sugars) together, and is also known as saccharification. Lignocellulosic material, in some embodiments, can comprise cellulose and/or hemicellulose, Cellulose is a glucan, which is a polysaccharide. Polysaccharides are polymeric compounds that are made up of repeating units of saccharides (e.g., monosaccharides or disaccharaides) that are linked together by glycosidic bonds. The repeating units of saccharides can be the same (i.e., homogenous) to result in a homopolysaccharide or can be different (i.e., heterogeneous) to result in a heteropolysaccharide. Cellulose can undergo hydrolysis to form cellodextrins shorter polysaccharide units compared to the polysaccharide units before the hydrolysis reaction) and/or glucose (i.e. a monosaccharide). Hemicellulose is a heteropolysaccharide and can include polysaccharides, including, but not limited to, xylan, glucuronoxylan, arabinoxylan, glucomannan and xyloglucan. Hemicellulose can undergo hydrolysis to form shorter polysaccharide units, and/or monosaccharides, including, but not limited to, pentose sugars, xylose, mannose, glucose, galactose, rhamnose, arabinose, or any combination thereof.

In some embodiments of the present invention, the pretreatment step partially hydrolyzes the lignocellulosic material. “Partial hydrolysis” or “partially hydrolyzes” and any grammatical variants thereof, as used herein, refer to the hydrolysis reaction cleaving or breaking less than 100% of the chemical bonds that hold the lignocellulosic material together. In other embodiments of the present invention, the hydrolysis reaction cleaves or breaks less than 100% of the glycosidic bonds of the cellulose and/or hemicellulose present in the lignocellulosic material. In some embodiments, the partial hydrolysis reaction can convert less than about 20%, 15%, 10%, or 5% of the cellulose into glucose. In further embodiments of this invention, the partial hydrolysis reaction can convert less than about 20%, 15%, 10%, or 5% of the hemicellulose into monosaccharides. Exemplary monosaccharides include but are not limited to, xylose, glucose, mannose, galactose, rhamnose, and arabinose. The partial hydrolysis reaction can result in the recovery of greater than about 80%, 85%, 90%, or 95% of the glucan present in the pretreated lignocellulosic material compared to the amount of glucan present in the lignocellulosic material before pretreatment. In some embodiments of the present invention, the partial hydrolysis reaction can result in the recovery of less than about 40%, 35%, 30%, 25%, 20%, 15%, 10%, or 5% of the xylan in the pretreated lignocellulosic material compared to the amount of xylan present in the lignocellulosic material before pretreatment.

In particular embodiments of the present invention, the production of undesirable products from lignocellulosic material as a result of the pretreatment step is reduced compared to other processes for the treatment of lignocellulosic material. As used herein, the terms “reduce,” “reduces,” “reduced,” “reduction” and similar terms refer to a decrease of at least about 5%, 10%, 25%, 35%, 50%, 75%, 80%, 85%, 90%, 95%, 97% or more. Exemplary undesirable products include furfural, acetic acid, 5-hydroxymethylfurfural (HMF), and formic acid. In some embodiments, the undesirable product is at a concentration in the pretreatment solution, filtrate and/or hydrolysate of less than about 35 g/kg, 30 g/kg, 25 g/kg, 20 g/kg, 15 g/kg, 10 g/kg, or 5 g/kg, and is thus reduced compared to other processes for treating lignocellulosic material. In other embodiments, the undesirable product is at a concentration in the pretreatment solution, filtrate and/or hydrolysate of less than about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 g/kg, or any range therein, and is thus reduced compared to other processes for treating lignocellulosic material.

In some embodiments of the present invention, the pretreatment step can break down and/or remove the lignin present in the lignocellulosic material. Lignin, in some embodiments, can be removed from the lignocellulosic material by hydrolysis of the chemical bonds that hold the lignocellulosic material together. Accordingly, in some embodiments of the present invention, the pretreatment step can result in the removal of about 60% or less (e.g., about 55%, 50%, 45%, 40%, 35%, 30%, 25%, 20%, etc.) or any range therein of the lignin in the pretreated lignocellulosic material compared to the amount of lignin present in the lignocellulosic material prior to the pretreating step. In some embodiments of the present invention, the pretreatment step can result in the recovery of about 40% or more (e.g., 45%, 50%, 55%, 60%, 65%, 70%, 75%, 80%, etc.) or any range therein of the lignin in the pretreated lignocellulosic material compared to the amount of lignin present in the lignocellulosic material prior to the pretreating step.

In other embodiments of the present invention, the pretreatment step can affect the structure of the lignocellulosic material. For instance, the pretreatment step can result in the dissociation of fibers in the lignocellulosic material, increase the porosity of the lignocellulosic material, increase the specific surface area of the lignocellulosic material, or any combination thereof. In some embodiments, the pretreatment step reduces the crystallinity of the cellulose structure by, for example, changing a portion of the cellulose from a crystalline state to an amorphous state.

The pretreatment step, in some embodiments of this invention, can make the pretreated lignocellulosic material more susceptible to enzymatic digestion compared to lignocellulosic material not subjected to a pretreatment step of the present invention. Thus, in some embodiments of the present invention, enzymatic digestion of the pretreated lignocellulosic material can be increased by two, three, four, five, six, seven, eight or more times compared to the enzymatic digestion of lignocellulosic material not pretreated with the pretreatment solution as described herein.

In further embodiments of the present invention, after treatment of the lignocellulosic material with the pretreatment solution as described herein, the lignocellulosic material can be separated from the pretreatment solution by any means known to those skilled in the art. A method of separating the lignocellulosic material from the pretreatment solution can include, but is not limited to, vacuum filtration, membrane filtration, sieve filtration, partial or coarse separation, or any combination thereof. The separating step can produce a liquid portion (i.e., filtrate or hydrolysate) and a solid residue portion (i.e., the pretreated lignocellulosic material). In some embodiments of the present invention, water is added to the pretreated lignocellulosic material before and/or after separation. Thus, in some embodiments of the present invention, the pretreated lignocellulosic material can optionally include the pretreatment solution and/or by-products from the pretreatment process, such as, but not limited to, ionic liquid(s), acid(s), and products produced from the pretreatment process.

Optionally, after pretreatment of the lignocellulosic material with the pretreatment solution, as described herein, the pretreated lignocellulosic material can be washed with a post-pretreatment wash solution. A post-pretreatment wash solution can comprise a basic solution and/or an organic solvent. A basic solution can have a pH of about pH 8 or greater (e.g., about pH 8, 9, 10, 11, 12, 13, or 14). In particular embodiments, the pH of a basic solution is about pH 10 or greater or about pH 12 or greater. A basic solution can comprise alkaline chemicals, such as, but not limited, to, sodium hydroxide, potassium hydroxide, ammonium hydroxide, and basic salts such as, but not limited to, sodium carbonate and potassium carbonate. The concentration of the alkaline chemical in the basic solution can be from about 0.0002% to about 12% by weight of the basic solution or any range therein, such as, but not limited to, about 0.002% to about 10%, about 0.02% to about 5%, or about 0.01% to about 0.5% by weight of the basic solution. In particular embodiments, the concentration of the alkaline chemical in the basic solution is about 0.2% by weight of the basic solution. In some embodiments of the present invention, a post-pretreatment wash solution comprises an organic solvent. Exemplary organic solvents for a post-pretreatment wash solution include, but are not limited, an alcohol, such as methanol and/or ethanol, acetone, and/or 1,4-dioxane.

A post-pretreatment wash can be carried out at a temperature from about 0° C. to about 100° C. or any range therein, such as, but not limited to, about 5° C. to about 80° C., about 5° C. to about 40° C., or about 15° C. to about 35° C. In particular embodiments, the post-pretreatment wash is carried out at about room temperature (i.e., about 25° C.).

In some embodiments of the present invention, a post-pretreatment wash with a post-pretreatment wash solution can be carried out before and/or after the pretreated lignocellulosic material is optionally washed with water. According to some embodiments of the present invention, the pretreated lignocellulosic material can be washed with water and/or a post-pretreatment wash solution one or more times, such as 2, 3, 4, or more times. In certain embodiments of the present invention, the pretreated lignocellulosic material can be washed with a basic solution after pretreatment. In other embodiments of the present invention, the pretreated lignocellulosic material can be washed with water one or more times after pretreatment, then the pretreated lignocellulosic material is washed with a basic solution one or more times, followed by optionally washing the pretreated lignocellulosic material with water one or more times. In some embodiments of the present invention, the pretreated lignocellulosic material can be washed with an organic solvent one or more times, then washed with water one or more times. In further embodiments of the present invention, after the one or more water and/or post-pretreatment wash solution washes, the pretreated lignocellulosic material can be separated from the water and/or post-pretreatment wash solution via methods such as, but not limited to, vacuum filtration, membrane filtration, sieve filtration, partial or coarse separation, or any combination thereof.

In certain embodiments of the present invention, a post-pretreatment wash with a post-pretreatment wash solution removes lignin present in the pretreated lignocellulosic material. In particular embodiments, a post-pretreatment wash with a post-pretreatment wash solution removes residual lignin present in the pretreated lignocellulosic material. The residual lignin can, in some embodiments, be present in the pretreated lignocellulosic material as a result of lignin condensing on the pretreated lignocellulosic material during and/or after pretreatment with a pretreatment solution of the present invention. In some embodiments of the present invention, the lignin present in the pretreated lignocellulosic material can be dissolved and/or removed by washing the pretreated lignocellulosic material with a post-pretreatment wash solution.

In some embodiments of the present invention, after pretreatment, the wash with a post-pretreatment wash solution can result in the removal of about 25% or more of lignin as compared to the lignin present in untreated lignocellulosic material (i.e., lignocellulosic material not treated with a pretreatment solution of the present invention and/or not treated with a post-pretreatment wash solution of the present invention). In certain embodiments of the present invention, after pretreatment, a wash with a post-pretreatment wash solution can result in the removal of about 25%, 30%, 35%, 40%, 45%, 50%, 55%, or more, or any range therein, of lignin compared to the lignin present in untreated lignocellulosic material. In particular embodiments of the present invention, after pretreatment, a wash with a post-pretreatment wash solution can result in the removal of about 25% to about 50%, or any range therein, of lignin as compared to the lignin present in untreated lignocellulosic material. Thus, in some embodiments, after a pretreatment and/or a post-pretreatment wash as described herein, the amount of lignin removed from the lignocellulosic material (i.e., the sum of the lignin removed from a pretreatment with a pretreatment solution of the present invention and a post-pretreatment wash with a post-pretreatment wash solution of the present invention) is about 60% or more, such as about 60%, 65%, 70%, 75%, 80%, 85%, 90%, 95%, or more compared to the lignin present in untreated lignocellulosic material. In certain embodiments, pretreatment with a pretreatment solution of the present invention and post-pretreatment with a post-pretreatment wash solution of the present invention removes about 65% of the lignin present in the lignocellulosic material prior to pretreatment and post-pretreatment. In certain embodiments of the present invention, the post-pretreatment wash solution is a basic solution

Optionally, a post-pretreatment wash solution can be collected after washing the pretreated lignocellulosic material. In some embodiments of the present invention, the collected post-pretreatment wash solution is a basic solution that can be used to recover lignin by adjusting the pH of the collected basic solution to an acidic pH (i.e., a pH of less than about 7) with an acid salt or acid, such as, but not limited to, hydrochloric acid, sulfuric acid, nitric acid, and phosphoric acid. In certain embodiments of the present invention, the pH of the collected basic solution is adjusted to a pH of about 1 to about 7 or any range therein, such as, but not limited to, about 1.5 to about 6.5 or about 2 to about 5. In some embodiments of the present invention, the temperature at which lignin is recovered can be from about 0° C. to about 90° C. or any range therein, such as, but not limited to, about 5° C. to about 70° or about 5° C. to about 40° C. The lignin can be recovered by precipitating the lignin from the collected basic solution and can be collected by filtration, such as, but not limited to, vacuum filtration, membrane filtration, sieve filtration, partial or coarse separation, or any combination thereof. The recovered lignin can be used for the production of a valuable product, such as, but not limited to, a combustion energy product, a phenol substitute in phenolic resins, a polymer additive, a construction material, or any combination thereof.

Without being bound to a particular theory, it is believed that the presence of lignin in the pretreated lignocellulosic material negatively affects the enzymatic hydrolysis of cellulose due to non-productive adsorption of the enzymes, such as cellulase, by lignin. Non-productive adsorption of the enzymes by lignin is believed to reduce the actual amount of the enzyme available for enzymatic hydrolysis. Thus, it is believed that by further removal of lignin present in the pretreated lignocellulosic material can improve the rate of enzymatic hydrolysis and reduce the amount of enzyme utilized in the enzymatic hydrolysis.

The filtrate or hydrolysate can be collected after and/or during separation for use in pretreating additional lignocellulosic material (i.e., recycling of the filtrate/hydrolysate). The filtrate or hydrolysate can be collected and reused two, three, four, or more times. Additional components can optionally be added to the recycled solution, including but not limited to, additional water, acid catalyst, ionic liquid, or any combination thereof. In some embodiments of the present invention, water is added to the recycled solution.

In some embodiments of the present invention, a pretreated lignocellulosic material can be subject to further processing conditions, such as, but not limited to, steam explosion.

In other embodiments of the present invention, the lignocellulosic material is treated with an aqueous acid solution prior to treatment with the pretreatment solution of the present invention (i.e., pre pretreatment). An aqueous acid solution can comprise, consist essentially of, or consist of mineral acids, Lewis acids, acidic metal salts, organic acids, solid acids, inorganic acids, or any combination thereof. One or more acids (e.g., 1, 2, 3, 4, 5, or more acids) can be present in the aqueous acid solution, and the acid(s) can be monoprotic or polyprotic and can comprise one, two, three, or more acid functional groups. Exemplary acids include, but are not limited to hydrochloric acid, sulfuric acid, phosphoric acid, hydrofluoric acid, hydrobromic acid, hydroiodic acid, nitric acid, formic acid, acetic acid, methanesulfonic acid, toluenesulfonic acid, boron trifluoride diethyletherate, scandium (III) trifluoromethanesulfonate, titanium (IV) isopropoxide, tin (IV) chloride, zinc (II) bromide, iron (II) chloride, iron (III) chloride, zinc (II) chloride, copper (I) chloride, copper (I) bromide, copper (II) chloride, copper (II) bromide, aluminum chloride, chromium (II) chloride, chromium (III) chloride, vanadium (III) chloride, molybdenum (III) chloride, palladium (II) chloride, platinum (II) chloride, platinum (IV) chloride, ruthenium (III) chloride, rhodium (III) chloride, zeolites, activated zeolites, or any combination thereof. In certain embodiments, the acid in the aqueous acid solution is hydrochloric acid.

In some embodiments of this invention, the acid(s) can be present in the aqueous acid solution in an amount from about 0.1% to about 5.0% by weight of the acid solution or any range therein, such as, but not limited to, about 0.1% to about 2.5% by weight of the acid solution. Thus, in some embodiments of the present invention, the acid(s) can be present in the acid solution in an amount of about 0.1%, 0.25%, 0.5%, 0.75%, 1%, 1.2%, 1.5%, 1.75%, 2%, 2.25%, 2.5%, 2.75%, 3%, 3.25%, 3.5%, 3.75%, 4%, 4.25%, 4.5%, 4.75%, 5%, or any range therein.

Another aspect of the present invention, provides a method of contacting a pretreated lignocellulosic material with at least one enzyme or an enzyme composition comprising at least one enzyme. A pretreated lignocellulosic material can include the pretreatment solution and/or by-products from the pretreatment process, such as, but not limited to, ionic liquid(s), acid(s), and products produced from the pretreatment process. In certain embodiments, a method of the present invention can increase the enzymatic digestibility of a pretreated lignocellulosic material compared to the enzymatic digestibility of untreated lignocellulosic material (i.e., lignocellulosic material not treated as described herein). In some embodiments, a method of the present invention can increase enzymatic digestibility of a pretreated lignocellulosic material by at least about 2 times or 3 times compared to the enzymatic digestibility of untreated lignocellulosic material.

In some embodiments, an enzyme or an enzyme composition is added to the pretreated lignocellulosic material. In other embodiments, water is added to the pretreated lignocellulosic material and the solid residue can be separated from the solution and enzymatically hydrolyzed.

The enzyme can be microbially produced and/or plant produced, and can include, but is not limited to, a cellulase, a hemicellulase, a xylanase, a ligninase, a pectinase, a protease, an amylase, a catalase, a cutinase, a glucanase, a glucoamylase, a glucose isomerase, a lipase, a laccase, a phytase, a pullulanase, a xylose isomerase, or any combination thereof. The enzyme compositions can be prepared as a liquid, slurry, solid or gel. In one aspect of the present invention, the enzyme is produced by the lignocellulosic plant material and retains its functional activity after pretreatment of the lignocellulosic material with the pretreatment solution. Accordingly, in some embodiments of the present invention, no additional enzyme(s) are contacted/added to the pretreated lignocellulosic material for enzymatic hydrolysis.

In particular embodiments of the present invention, the enzyme is a cellulase and/or xylanase. “Cellulase” or “cellulases”, as used herein, refer to an enzyme capable of hydrolyzing cellulose to glucose. Non-limiting examples of cellulases include mannan endo-1,4-β-mannosidase, 1,3-β-D-glucan glucanohydrolase, 1,3-β-glucan glucohydrolase, 1,3-1,4-β-D-glucan glucanohydrolase and 1,6-β-D-glucan glucanohydrolase.

“Xylanase” or “xylanases”, as used herein, refer to an enzyme capable of at least hydrolyzing xylan to xylobiose and xylotriose. Exemplary xylanases can be from a Dictyoglomus sp. including, but not limited to, Dictyoglomus thermophilium Rt46B.1. See, e.g., Gibbs et al. (1995) Appl. Environ. Microbiol. 61:4403-4408.

In some embodiments of the present invention, an enzyme can be a high-temperature (i.e., thermostable) and/or low-pH (i.e., acidophilic) tolerant enzyme. By “thermostable” or “thermotolerant” is meant that the enzyme retains at least about 70% activity at about 60° C. for 30 minutes, at least about 65% activity at about 70° C. for 30 minutes, or at least about 60% activity at about 80° C. for 30 minutes. “Acidophilic”, as used herein, means that the enzyme retains about 60% to about 90% of its activity at pH 6, retains at least about 65% activity at pH 5.0, or retains at least about 60% activity at pH 4.0.

In some embodiments of the present invention, an enzyme can be a dual activity enzyme. A “dual activity enzyme”, as used herein, refers to an enzyme having both xylanase and cellulase activity. The dual activity enzyme can be thermotolerant and/or acidophilic.

Additional nonlimiting examples of enzymes include α-L-arabinofuranosidase, α-glucuronidase, acetyl mannan esterase, acetyl xylan esterase, α-galactosidase, β-glucosidase, exoxylanase, β-1,4-xylosidase, endo-1,4-β-xylanase, endo-galactanase, endo-β-1,4-mannanase, 1,4-β-D-glucan, cellobiohydrolase, endo-1,4-β-D-glucanase, β-glucosidase, endo-α-1,5-arabinanase, exo-β-1,4-mannosidase, cellobiohydrolases, endoglucanase, exo-β-1,4-xylosidase, feruloyl esterase, ferulic acid esterase, p-cumaric acid esterase, glucuronoxylan xylanohydrolase, xyloglucan endotransglycosylase, diarylpropane peroxidase, glucose oxidase, glyoxal oxidase, lignin peroxidase (LiP), manganese peroxidase, methanol oxidase, methanol oxidoreductase, phenol oxidase (laccase), phenol peroxidase, veratryl alcohol oxidase, pectolyase, pectozyme, polygalacturonase, asclepain, bromelain, caricain, chymopapain, collagenase, glycyl endopeptidase, pepsin, pronase, subtilisin, thermolysin or any combination thereof.

An enzyme can be provided as a partially or fully purified full-length enzyme, or active variants or fragments thereof, or can be provided as an enzyme-producing microorganism. Moreover, any of these enzymes can be provided in an amount effective to hydrolyze their substrate (e.g., the pretreated lignocellulosic material, which can optionally include the pretreatment solution and/or by-products from the pretreatment process, such as, but not limited to, ionic liquid(s), acid(s), and products produced from the pretreatment process), such as in amounts from about 0.001% to about 50%, from about 0.01% to about 50%, from about 0.1% to about 50%, from about 1% to about 50%, from about 10% to about 50%, from about 20% to about 50%, from about 30% to about 50%, from about 40% to about 50% by weight of the substrate, or more.

An enzyme composition also can include agents known to those of skill in the art for use in processing lignocellulosic material (e.g., biomass) including, but not limited to, a chlorine, detergent, hypochlorite, hydrogen peroxide, oxalic acid, peracid, pH-regulating agent, trisodium phosphate, sodium chlorite, sodium nitrate, surfactant, urea, buffer(s), and/or water.

Examples of detergents include, but are not limited to, anionic, cationic or neutral detergents such as Nonidet (N)P-40, sodium dodecyl sulfate (SDS), sodium lauryl sulfate (SLS), sulfobetaine, n-octylglucoside, deoxycholate, Triton® X-100 (Dow Chemical Co.; Midland, Mich.) and/or Tween® 20 (ICI Americas, Inc.; Bridgewater, N.J.).

Non-limiting examples of surfactants include a secondary alcohol ethoxylate, a fatty alcohol ethoxylate, a nonylphenol ethoxylate, a phosphate ester of fatty alcohols, a polyoxyethylene ether, a polyethylene glycol, a polyoxyethylenated alkyl phenol, a stearic acid and/or a tridecyl ethoxylate.

Any of the agents can be provided as partially or fully purified. Moreover, any of these agents can be provided in an amount from about 0.001% to about 50%, from about 0.01% to about 50%, from about 0.1% to about 50%, from about 1% to about 50%, from about 10% to about 50%, from about 20% to about 50%, from about 30% to about 50%, from about 40% to about 50% by weight of the substrate, or more.

An enzyme composition of the present invention also can include fungi or other enzyme producing microorganisms, especially ethanologenic and/or lignin-solubilizing microorganisms, that can aid in processing, breaking down, and/or degrading lignocellulosic material. Non-limiting examples of ethanologenic and/or lignin-solubilizing microorganisms include bacteria and yeast. See generally, Burchhardt & Ingram (1992) Appl. Environ. Microbial. 58:1128-1133; Dien et al. (1998) Enzyme. Microb. Tech. 23:366-371; Keating et al. (2004) Enzyme Microb. Tech. 35:242-253; Lawford & Rousseau (1997) Appl. Biochem. Biotechnol. 63-65:221-241; Handbook on Bioethanol: Production and Utilization (Wyman ed., CRC Press 1996); as well as U.S. Patent Application Publication Nos. 2009/0246841 and 2009/0286293; and U.S. Pat. No. 6,333,181. Such microorganisms can produce enzymes that assist in processing lignocellulosic material including, but not limited to, alcohol dehydrogenase, pyruvate decarboxylase, transaldolase, transketolasepyruvate decarboxylase, xylose reductase, xylitol dehydrogenase or xylose isomerase xylulokinase. In some embodiments of the invention, the ethanologenic and/or lignin-solubilizing microorganisms include, but are not limited to, members of the genera Candida, Erwinia, Escherichia, Klebsiella, Pichia, Saccharomyces, Streptomyces and Zymomonas. See, e.g., Dien (1998), supra; Ingram & Conway (1988) Appl. Environ. Microbial. 54:397-404; Jarboe et al. (2007) Adv. Biochem. Engin./Biotechnol. 108:237-261; Keating et al. (2004) J. Indust, Microbiol. Biotech, 31; 235-244; Keating et al. (2006) Biotechnol. Bioeng. 93:1196-1206; Pasti et al. (1990) Appl. Environ. Microbial. 56:2213-2218; and Zhang et al. (1995) Science 267:240-243.

The methods of the present invention can further comprise contacting (e.g., fermenting) the pretreated lignocellulosic material, optionally including the pretreatment solution and/or by-products from the pretreatment process (e.g., ionic liquid(s), acid(s), and products produced from the pretreatment process), with a microorganism, including, but not limited to, an ethanologenic bacteria, a yeast or a combination thereof. In some embodiments, the contacting can be at a pH in a range from about 2 to about 9. In further embodiments of the present invention, the pretreated lignocellulosic material can then be processed for the production of fermentable sugars and/or for biofuel (e.g., ethanol) production.

The compositions and methods described herein can be used to process lignocellulosic material (e.g., biomass) to many useful organic chemicals, fuels and products. For example, some commodity and specialty chemicals that can be produced from lignocellulosic material include, but are not limited to, acetone, acetate, butanediol, cis-muconic acid, ethanol, ethylene glycol, furfural, glycerol, glycine, lysine, organic acids (e.g., lactic acid), 1,3-propanediol, polyhydroxyalkanoates, and xylose. Likewise, animal feed and various food/beverages can be produced from lignocellulosic material. See generally, Lynd et al, (1999) Biotechnol, Prog. 15:777-793; Philippidis, “Cellulose bioconversion technology” pp 179-212 In: Handbook on Bioethanol: Production and Utilization, ed. Wyman (Taylor & Francis 1996); and Ryu & Mandels (1980) Enz. Microb. Technol. 2:91-102. Potential co-production benefits extend beyond the synthesis of multiple organic products from fermentable carbohydrate in lignocellulosic material. For example, lignin-rich residues remaining after processing can be converted to lignin-derived chemicals or can be used for power production.

In some embodiments of the present invention, the compositions and/or methods described herein can be used to produce a pulp, such as a high value pulp. The pulp produced using the compositions and/or methods of the present invention can be used for the production of various materials and/or products, such as, but not limited to, paper, textile, and microcrystalline cellulose.

In particular embodiments, the methods of the present invention comprise enzymatically hydrolyzing the pretreated lignocellulosic material to produce a fermentable sugar. “Fermentable sugar,” as used herein, refers to oligosaccharides and/or monosaccharides that can be used as a carbon source by a microorganism in a fermentation process. Exemplary fermentable sugars include glucose, xylose, arabinose, galactose, mannose, rhamnose, sucrose, fructose, or any combination thereof.

The fermentable sugars can be converted to useful value-added fermentation products, non-limiting examples of which include amino acids, such as lysine, methionine, tryptophan, threonine, and aspartic acid; vitamins; pharmaceuticals; animal feed supplements; specialty chemicals; chemical feedstocks; plastics; solvents; fuels or other organic polymers; lactic acid; butanol and/or ethanol, including fuel ethanol and/or fuel butanol; organic acids, including citric acid, succinic acid and maleic acid; and/or industrial enzymes, such as proteases, cellulases, amylases, glucanases, lactases, lipases, lyases, oxidoreductases, transferases and xylanases.

In certain embodiments of the present invention, after pretreatment of the lignocellulosic material with the pretreatment solution, additional quantities of acid catalyst(s) and/or water can be added to hydrolyze the pretreated lignocellulosic material and/or to produce a fermentable sugar. The pretreated lignocellulosic material can optionally include the pretreatment solution and/or by-products from the pretreatment process, such as, but not limited to ionic liquid(s), acid(s), and products produced from the pretreatment process. The hydrolysis and/or production of fermentable sugars with additional quantities of acid catalyst(s) and/or water from the pretreated lignocellulosic material can be carried out with acid catalyst(s), as described above for the pretreatment step, at temperatures, as described above for the pretreatment step. The additional quantities of acid catalysts) and/or water can be added in amounts as described above for the pretreatment step that are based on the total weight of the pretreated lignocellulosic solution or composition (i.e., the pretreated lignocellulosic material can be in a liquid, slurry, solid or gel). For example, additional acid catalyst(s) can be added to the pretreated lignocellulosic material to have a concentration of about 0.1% to about 10.0% by weight of the pretreated lignocellulosic solution or composition or of about 1% to about 25% by weight of the dry lignocellulosic material, and additional water can be added to the pretreated lignocellulosic material to have a concentration of about 1% to about 80% by weight of the pretreated lignocellulosic solution or composition.

In certain embodiments, the additional ionic liquid(s) and/or acid(s) used to hydrolyze and/or produce a fermentable sugar are the same as the ionic liquid(s) and/or acid(s) used in the pretreatment step. In other embodiments, the additional ionic liquid(s) and/or acid(s) used to hydrolyze and/or produce a fermentable sugar are different than the ionic liquid(s) and/or acid(s) used in the pretreatment step. In some embodiments, additional quantities of water are added after the pretreatment step and/or after the separation step. In other embodiments, additional quantities of water and acid(s) are added after the pretreatment step and/or after the separation step. In certain embodiments, water is present in an amount of about 20%, 25%, 30%, 35%, or 45% or more by weight of the total solution or composition.

In some embodiments of the present invention, after the additional treatment and/or enzymatic hydrolysis of the pretreated lignocellulosic material, the product(s) (e.g., a fermentable sugar, ethanol, butanol, etc.) can be separated from the liquid, slurry, solid or gel. Ionic liquid(s) and/or acid(s) can be collected after separation for use in pretreating and/or additional treatment steps (i.e., recycling of the ionic liquid(s) and/or acid(s)).

In certain embodiments of the present invention, the total period of time for converting the lignocellulosic material into fermentable sugars can be from about 1 hour to about 35 hours, about 2 hours to about 30 hours, or about 2 hours to about 20 hours. In particular embodiments, the total period of time for converting the lignocellulosic material into fermentable sugars can be from about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 hours or any range therein. In certain embodiments of the present invention, the total period of time for converting the lignocellulosic material into fermentable sugars is less than about 20 hours.

The following examples are included to demonstrate various embodiments of the invention and are not intended to be a detailed catalog of all the different ways in which the present invention may be implemented or of all the features that may be added to the present invention. Persons skilled in the art will appreciate that numerous variations and additions to the various embodiments may be made without departing from the present invention. Hence, the following descriptions are intended to illustrate some particular embodiments of the invention, and not to exhaustively specify all permutations, combinations and variations thereof.

### EXAMPLES

### Example 1

### Materials and Methods

### Bagasse Pretreatment and Sample Analysis

The bagasse samples in the following examples were prepared according to the methods described herein with the specific conditions, such as the concentration of the components in the pretreatment solutions and the reaction conditions, provided in the specific examples below.

Air-dried depithed bagasse was ground and the material retained between a 0.25 mm and 0.5 mm sieve was collected. 4.30 grams (moisture content of 6.9%) of the collected bagasse was mixed with 40 grams of the pretreatment solution (e.g., water, acid, and 1-n-butyl-3-methylimidazolium chloride (BMIMCl) in a 100 mL glass flask. The mixture was stirred at 500 rpm and heated to the indicated temperature for a set period of time, as set forth in each example below. After pretreatment, the mixture was vacuum-filtered to produce a filtrate (i.e., hydrolysate) portion and a solid residue portion (i.e., pretreated bagasse). A portion of the filtrate (i.e., hydrolysate) was analyzed for glucose, xylose, organic acids, 5-hydroxymethylfurfural (HMF) and furfural content by high performance liquid chromatography (HPLC) using an Aminex HPX 87H column (Bio-Rad). The solid residue (i.e., pretreated bagasse) was washed 4 times with 400 mL of distilled water and then filtered. The washed solid residue was kept at 2° C.-6° C. prior to enzymatic digestibility analysis.

A portion of the solid residue was freeze-dried for composition analysis (e.g., glucan, xylan, and lignin content) by the Laboratory Analytical Procedure (NREL, 2008). A further portion of the freeze-dried sample was analyzed by Fourier transform infra-red (FTIR) spectroscopy and scanning electron microscopy (SEM).

The effects of various pretreatment conditions on the digestibility of bagasse were examined in the following examples, including (a) acid type, (b) acid concentration, (c) water content, (d) BMIMCl concentration, (e) reaction temperature, and (f) pretreatment time.

The glucan, xylan, or lignin content in pretreated bagasse residue was calculated based on the following formula:

$$Glucan \text{/} xylan \text{/} lignin content = \frac{Total glucan \text{/} xylan \text{/} lignin in pretreated bagasse residue \times 100 \%}{Dry weight of pretreated bagasse residue}$$

The glucan, xylan, or lignin recovery was calculated based on the following formula:

$$Glucan \text{/} xylan \text{/} lignin recovery = \frac{Total glucan \text{/} xylan \text{/} lignin in pretreated bagasse residue \times 100 \%}{Total glucan \text{/} xylan \text{/} lignin in untreated bagasse}$$

Glucose yield in the pretreatment hydrolysate was calculated based on, the following formula:

$$Glucose yield = \frac{Total glucose measured in hydrolysate \times 100 \%}{Total glucan in untreated bagasse \times 1.111}$$

Xylose yield in the hydrolysate was calculated based on the following formula:

$$Xylose yield = \frac{Total xylose measured in hydrolysate \times 100 \%}{Total xylan in untreated bagasse \times 1.136}$$

Furfural yield in the hydrolysate was calculated based on the following formula:

$$Furfural yield = \frac{Total furfural measured in hydrolysate \times 100 \%}{Total xylan and arabinan in untreated bagasse \times 0.727}$$

HMF yield in the hydrolysate was calculated based on the following formula:

$$HMF yield = \frac{Total HMF measured in hydrolysate \times 100 \%}{Total glucan in untreated bagasse \times 0.778}$$

The yields of glucose, xylose, HMF, furfural, and acetic acid in the pretreatment hydrolysate were also calculated based on the dry weight of untreated bagasse. These yields were calculated based on the following formula:

$$Glucose yield = \frac{Total glucose in pretreatment hydrolysate \times 100 \%}{Total glucan in untreated bagasse \times 1.111}$$

$$Xylose yield = \frac{Total glucose in pretreatment hydrolysate \times 100 \%}{Dry weight of untreated bagasse}$$

$$HMF yield = \frac{Total HMF in pretreatment hydrolysate \times 100 \%}{Dry weight of untreated bagasse}$$

$$Furfural yield = \frac{Total furfural in pretreatment hydrolysate \times 100 \%}{Dry weight of untreated bagasse}$$

$$Acetic acid yield = \frac{Total acetic acid in pretreatment hydrolysate \times 100 \%}{Dry weight of untreated bagasse}$$

### Measurement of Enzymatic Digestibility

Enzymatic hydrolysis was conducted in a 20 mL bottle containing 5 mL of enzyme solution. The enzymatic hydrolysis was carried out at 50° C. for 72 hours. In each bottle, the pretreated bagasse contained an equivalent of 2% cellulose loading. The enzyme Accellerase® was used for the enzymatic hydrolysis of the pretreated bagasse in an amount of 0.5 mL enzyme solution per gram pretreated bagasse. Accellerase® is an enzyme mixture containing cellulases and xylanases.

Enzymatic digestibility was calculated based on the amount of glucose released by the enzymatic hydrolysis compared to the total glucan present in the pretreated bagasse before enzymatic hydrolysis.

Digestibility was calculated based on the following formula:

$$Digestibility = \frac{Total glucose after enzymatic hydrolysis \times 100 \%}{Total glucan in pretreated bagasse \times 1.111}$$

The total glucose yield after enzymatic hydrolysis was calculated based on the following formula:

$$Total glucose yield = \frac{Total glucose after enzymatic hydrolysis \times 100 \%}{Total glucan in untreated bagasse \times 1.111}$$

### Example 2

### FTIR Data of Untreated Bagasse and Pretreated Bagasse

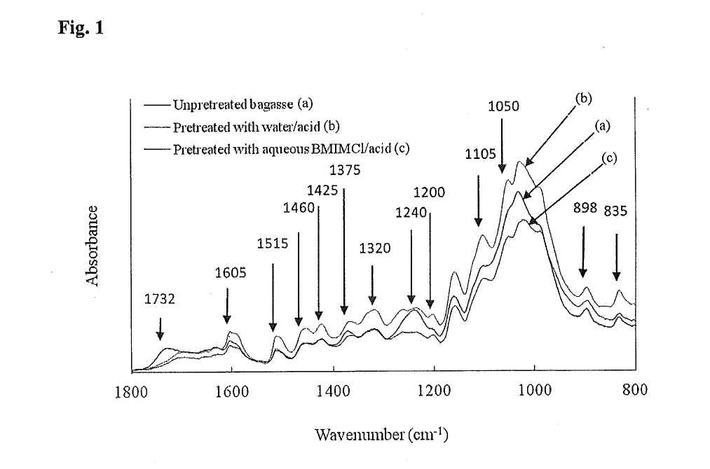

FIG. 1 shows the FTIR spectra of untreated bagasse, the it spectra of the solid residue from bagasse pretreated with water containing 1.2% HCl, and the FFIR spectra of the solid residue from bagasse pretreated with a BMIMCl solution containing 1.2% HCl and 10% water. For the FTIR data, a number of bands were used to monitor the chemical changes of lignin and carbohydrates. In general, the patterns of the FTIR spectra of the solid residues from bagasse pretreated with water/acid and aqueous BMIMCl/acid were similar but the intensities of some bands were different. The ester bond signal at 1732 cm⁻¹ stunted after pretreatment compared to the untreated sample, suggesting that some ester linkages between lignin and carbohydrates were cleaved during pretreatment (Liu et al., 2009). The peaks at 1605 cm⁻¹ and 1515 cm⁻¹, relating to the aromatic skeleton vibrations in lignin (Liu et al., 2009), were more prominent in the solid residue from bagasse pretreated with water/acid compared to untreated bagasse, indicating that the pretreatment process increases the proportion of lignin in the solid residue. This is consistent with the lignin content shown in Table 1, The increase in band intensities was also observed at 1460 cm⁻¹ and 1425 cm⁻¹ for the solid residue with water/acid treatment. This may be attributed to a higher content of methoxy groups (—OCH₃) present in lignin (Guo et al., 2008).

A phenolic hydroxyl group band was observable at 1375 cm⁻¹ for all samples. The phenolic hydroxyl group is one of the common functional groups associated with the lignin structure (Guo et al, 2008; Li et al., 2009). The peak at 1320 cm⁻¹ is attributed to C—H vibration in cellulose and Cl—O vibrations in syringyl derivatives (Zhao et al., 2008). The band intensity at 1320 cm⁻¹ increased for the solid residue obtained with water/acid treatment compared to untreated bagasse and the solid residue from acidic ionic liquid treatment. This may be due to higher syringyl lignin content in water/acid, pretreated bagasse. The increase in band intensities at around 1200 cm⁻¹ for the solid residue from pretreated bagasse suggests an increased contribution from OH groups (Guo et al., 2008). The peak at 1240 cm⁻¹ is assigned to ether bonds (ar-C—O—C-al) (Liu et al., 2009). It reduced in the spectrum of acid-treated bagasse and almost disappeared in the spectrum of acidic ionic liquid-treated bagasse. Without wishing to be bound to any particular theory, this may mean that pretreatment with an acidic ionic liquid solution is more effective in removing ether linkages between lignin and carbohydrates than dilute acid pretreatment.

The band intensities at 1105 cm⁻¹, which correspond to crystalline cellulose (Li et al., 2010), were stronger for the acid pretreated residues. Without wishing to be bound to any particular theory, this is believed to indicate that the acid pretreatment increased biomass crystallinity by the effective removal of amorphous hemicellulose component. The peak at 1050 cm⁻¹ may be attributed to the first hydroxyl group in lignin (Guo et al., 2008). It was prominent in both the pretreated samples. The peak at 898 cm⁻¹ is characteristic of β-glycosidic linkages, and demonstrates the presence of predominant β-glycosidic linkages between the sugar units in cellulose and hemicellulose (Liu et al., 2009). The peak at 835 cm⁻¹ belongs to a C—H out of plane vibration in lignin (Zhao et al., 2008) and was lower in intensity in the solid residue obtained with acidic ionic liquid solution. This result is consistent with the chemical analysis data shown in Table 1.

### Example 3

### SEM of Untreated Bagasse and Pretreated Bagasse

Scanning electron microscopy (SEM) analysis was conducted to study changes in bagasse morphology. The bagasse samples were either untreated or pretreated with an acid solution or a BMIMCl/acid/water solution for 30 minutes at 130° C. The acid solution contained 1.2% HCl and 98.8% water. The BMIMCl/acid/water solution contained 78.8% BMIMCl, 1.2% HCl, and 20% water.

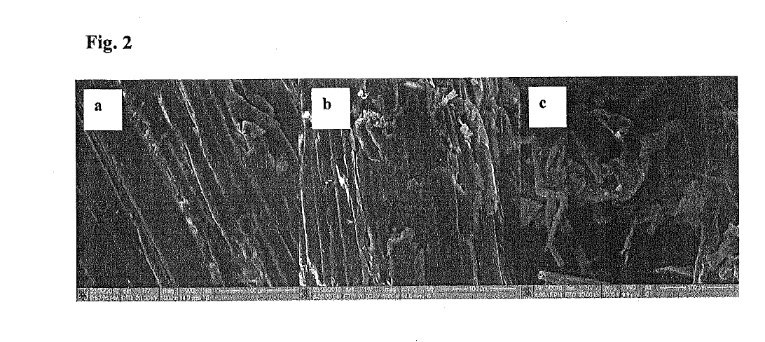

As shown in FIG. 2, the untreated bagasse sample exhibited grid and compact fibrils (FIG. 2a), which hinder the ability of the enzymes to access the cellulosic and hemicellulosic components of the bagasse (i.e., the lignocellulosic material) during saccharification. The morphology of bagasse pretreated with the acid solution did not change significantly compared to untreated bagasse (FIG. 2b), although some pores appeared in the acid pretreated bagasse. In contrast, pretreatment with the BMIMCl/acid/water solution destroyed the rigid structure of bagasse (FIG. 2c). Without being bound to a particular theory, this may be attributed to the removal of hemicellulose and some of the lignin from the bagasse pretreated with the BMIMCl/acid/water solution, resulting in the dissociation of the fibrils, increased porosity and increased specific surface area of the pretreated bagasse.

### Example 4

### Effect of BMIMCl Concentration in the Pretreatment Solution on the Content, Recovery, and Enzymatic Digestibility of the Pretreated Bagasse

The effect of varying the amount of BMIMCl in the BMIMCl/HCl/water pretreatment solution was examined. The concentrations of BMIMCl, HCl, and water used in the various BMIMCl/HCl/water pretreatment solutions are given in Table 1 along with the results on the content, recovery, and enzymatic digestibility of the pretreated bagasse. The bagasse samples were pretreated with the pretreatment solutions at 130° C. for 30 minutes.

TABLE 1
Pretreatment of bagasse using various BMIMCl
concentrations in the pretreatment solution.

| Water/ | Content in | | | Recovery in | | | | Total |
|---|---|---|---|---|---|---|---|---|
| BMIMCl/ | solid residue | | | solid residue | | | | glucose |
| HCl | (%) | | | (%) | | | Digestibility | yield (72 h, |
| (%) | Glucan | Xylan | Lignin | Glucan | Xylan | Lignin | (24 h/72 h, %) | %) |
| 3.0/95.8/1.2 | 63.5 | 0.0 | — | 52.7 | 0.0 | — | 97.5/100.0 | 52.7 |
| 10.0/88.8/1.2 | 72.1 | 1.0 | 24.3 | 85.6 | 2.2 | 45.8 | 98.2/100.0 | 85.6 |
| 20.0/78.8/1.2 | 69.6 | 1.9 | 25.9 | 92.8 | 4.8 | 54.9 | 94.5/97.5 | 90.5 |
| 30.0/68.8/1.2 | 65.4 | 5.8 | 26.1 | 93.4 | 15.6 | 59.2 | 89.3/93.7 | 87.5 |
| 50.0/58.8/1.2 | 63.7 | 6.9 | 27.0 | 94.2 | 19.2 | 63.4 | 65.3/83.5 | 78.7 |
| 98.8/0.0/1.2 | 56.3 | 8.5 | 31.0 | 95.1 | 27.0 | 83.2 | 32.5/38.4 | 36.5 |

Table 2 shows the concentration of various components detected in the hydrolysate after bagasse pretreatment with the BMIMCl/acid/water pretreatment solutions comprising 1.2% HCl at 130° C. for 30 minutes. The proportion of glucose in the hydrolysate decreased with increasing BMIMCl concentration. Without being bound to a particular theory, this is believed to be attributed to the generation of more 5-hydroxymethylfurfural (HMF). HMF, which is a dehydration product of glucose, decreased with decreasing BMIMCl concentration.

Xylose concentration increased as the BMIMCl concentration in the pretreatment solution decreased. The furfural values obtained increased with increasing water concentration from 10% to 20% in the pretreatment solution, and decreased with increasing water concentration from 20% to 50% in the pretreatment solution. Pretreatment solutions with high BMIMCl concentrations were expected to have higher concentrations of xylose and furfural than pretreatment solutions with lower BMIMCl concentrations since pretreatment solutions with higher BMIMCl concentrations are likely to have higher acidity. It is therefore likely that some compounds may have been converted to unidentified products.

The concentration of acetic acid in the hydrolysate, which was produced as a result of the pretreatment, varied among the pretreatment solutions from 4.4 g/kg solution to 4.7 g/kg solution.

TABLE 2
Composition of the hydrolysates obtained after bagasse pretreatment
with pretreatment solutions comprising 1.2% HCl and varying water
and BMIMCl concentrations.

| Water/ | Yield on bagasse (%) | | | | | Yield on | | Yield on | |
|---|---|---|---|---|---|---|---|---|---|
| BMIMCl/HCl | | | | | Acetic | glucan (%) | | xylan (%) | |
| (%) | Glucose | Xylose | HMF | Furfural | acid | Glucose | HMF | Xylose | Furfural* |
| 3.0/95.8/1.2 | 0.3 | 2.3 | 2.6 | 2.3 | 4.7 | 0.8 | 7.9 | 0.9 | 13.2 |
| 10.0/88.8/1.2 | 0.6 | 1.4 | 0.6 | 4.0 | 4.7 | 1.2 | 1.8 | 5.4 | 22.8 |
| 20.0/78.8/1.2 | 1.0 | 5.0 | 0.3 | 5.6 | 4.6 | 2.1 | 0.9 | 19.3 | 32.0 |
| 30.0/68.8/1.2 | 1.3 | 12.3 | — | 4.1 | 4.4 | 2.7 | — | 47.5 | 23.4 |
| 50.0/48.8/1.2 | 0.8 | 18.9 | — | 0.7 | 4.4 | 1.7 | — | 73.0 | 4.0 |
| 98.8/0.0/1.2 | 0.6 | 21.7 | — | 0.1 | 4.4 | 1.2 | — | 79.2 | 0.7 |

*The furfural yields were estimated based on the total amount of xylan and arabinan.

### Example 5

### Effect of Working Temperature and Acid Concentration in the Pretreatment Solution on the Content, Recovery, and Enzymatic Digestibility of the Pretreated Bagasse

Table 3 shows the effects of various temperatures and various acid concentrations on the content, recovery, and enzymatic digestibility of the pretreated bagasse. Each of the pretreatment solutions contained BMIMCl, HCl, and water at concentrations shown in Table 3. The bagasse samples were pretreated with the pretreatment solutions at 90° C., 110° C., or 130° C. for 30 minutes.

The bagasse pretreated with a pretreatment solution comprising 1.2% HCl at a working temperature of 130° C. achieved the highest amount of glucan in the bagasse, a greater enzymatic digestibility, and removed most of the xylan present in the bagasse.

For each of the pretreatment solutions, the glucan content in the solid residue (i.e., pretreated bagasse) was approximately 60%, regardless of the acid concentration used in the pretreatment solution. The highest total glucose yield after enzymatic hydrolysis was achieved by pretreating a bagasse sample with a pretreatment solution comprising 78.8% BMIMCl, 1.2% HCl, and 20% water at 130° C.

TABLE 3
Pretreatment of bagasse using BMIMCl/HCl/water pretreatment solutions
comprising various acid concentrations at 90° C., 110° C. or
130° C. for 30 minutes.

| | Content | | Recovery | | | Total |
|---|---|---|---|---|---|---|
| BMIMCl/HCl/water | in solid | | in solid | | | glucose |
| percentage | residue (%) | | residue (%) | | Digestibility | yield |
| and temperature | Glucan | Xylan | Glucan | Xylan | (%) | (%) |
| 76.4/3.6/20.0, 90° C. | 60.0 | 9.2 | 94.8 | 27.4 | 63.1 | 59.8 |
| 77.6/2.4/20.0, 110° C. | 63.2 | 7.3 | 93.1 | 20.2 | 91.8 | 85.5 |
| 78.8/1.2/20.0, 110° C. | 60.7 | 8.0 | 93.6 | 23.2 | 79.1 | 74.0 |
| 78.8/1.2/20.0, 130° C. | 69.6 | 1.9 | 92.8 | 4.8 | 97.5 | 90.5 |
| 79.6/0.4/20.0, 130° C. | 62.3 | 6.9 | 94.5 | 19.7 | 92.8 | 87.7 |

### Example 6

### Effect of Reaction Time on the Content, Recovery, and Enzymatic Digestibility of the Pretreated Bagasse

Table 4 shows the effect of reaction time on the content, recovery, and enzymatic digestibility of the pretreated bagasse. The bagasse samples were pretreated with a pretreatment solution comprising 1.2% HCl, 78.8% BMIMCl, and 20% water at 130° C. for 15, 30, or 45 minutes.

A higher proportion of xylan was removed from the pretreated bagasse as the pretreatment time increased. Even after pretreatment for 15 minutes, the content of glucan in the solid residue was over 60% and the enzymatic digestibility was 92.6% after a 72 hour enzymatic hydrolysis. As shown in Table 4, longer pretreatment times resulted in 100% digestibility.

TABLE 4
Pretreatment of bagasse with a pretreatment solution
comprising 1.2% HCl, 78.8% BMIMCl, and 20.0% water at
130° C. for 15, 30, or 45 minutes.

| | Content in | | Recovery in | | | Total |
|---|---|---|---|---|---|---|
| Pre- | solid residue | | solid residue | | | glucose |
| treatment | (%) | | (%) | | Digestibility | yield |
| time | Glucan | Xylan | Glucan | Xylan | (%) | (%) |
| 15 min | 63.4 | 6.2 | 93.3 | 17.2 | 92.6 | 86.4 |
| 30 min | 69.6 | 1.9 | 92.8 | 4.8 | 97.5 | 90.5 |
| 45 min | 70.1 | 1.1 | 92.1 | 2.7 | 100.0 | 92.1 |

### Example 7

### Use of H₂SO₄ as the Acid Catalyst in the Pretreatment Solution

Table 5 shows the glucan and xylan content in the solid residue (%) and total recovery in the solid residue (%) after bagasse pretreatment at 130° C. for 30 or 60 minutes with a BMIMCl/acid/water pretreatment solution using. H₂SO₄ as the acid catalyst. As shown in Table 5, complete enzymatic digestion (100%) was achieved after a 72 hour enzymatic hydrolysis using a pretreatment solution comprising 88.4% BMIMCl, 10% water, and 1.6% H₂SO₄ for 30 min and using a pretreatment solution comprising 78.4% BMIMCl, 20% water, and 1.6% H₂SO₄ for 60 min. However, the pretreatment solution comprising 10% water resulted in a loss of more glucan in the solid residue compared to the pretreatment solution comprising 20% water. As a result, the highest total glucose yield after enzymatic hydrolysis of 90.8% was achieved with bagasse pretreated for 60 minutes with the pretreatment solution comprising 78.4% BMIMCl, 20% water, and 1.6% H₂SO₄, followed by bagasse pretreated for 30 minutes with the pretreatment solution comprising 78.4% BMIMCl, 20% water, and 1.6% H₂SO₄, and then bagasse pretreated for 30 minutes with the pretreatment solution comprising 78.4% BMIMCl, 20% water, and 1.6% H₂SO₄.

TABLE 5
Pretreatment of bagasse using H₂SO₄ as the
acid catalyst in the pretreatment solution.

| | Content | | | | | Total |
|---|---|---|---|---|---|---|
| Water/BMIMCl/ | in solid | | Total recovery in | | | glucose |
| H₂SO₄ (%) | residue (%) | | solid residue (%) | | Digestibility | yield |
| and pretreatment time | Glucan | Xylan | Glucan | Xylan | (%) | (%) |
| 10.0/88.4/1.6, 30 min | 68.2 | 1.0 | 87.9 | 2.3 | 100.0 | 87.9 |
| 20.0/78.4/1.6, 30 min | 65.1 | 5.5 | 94.3 | 15.0 | 93.5 | 88.2 |
| 20.0/78.4/1.6, 60 min | 69.1 | 2.9 | 90.8 | 7.1 | 100.0 | 90.8 |
| Untreated bagasse | 42.9 | 22.8 | 100.0 | 100.0 | 6.9 | 6.9 |

### Example 8

### Use of FeCl₃ as the Acid Catalyst in the Pretreatment Solution

Table 6 shows the glucan and xylan content in the solid residue (%) and total recovery in the solid residue (%) after bagasse pretreatment at 130° C. for 30 min, 60 min, or 120 min with a BMIMCl/acid/water pretreatment solution using FeCl₃ as the acid catalyst. The highest glucan digestibility was 100% for bagasse pretreated for 60 minutes with a pretreatment solution comprising 88.2% BMIMCl, 10% water, and 1.8% FeCl₃. Digestibility was increased by increasing pretreatment time and FeCl₃ concentration in the pretreatment solution and decreasing water concentration in the pretreatment solution.

TABLE 6
Pretreatment of bagasse using FeCl₃ as the acid catalyst in
the pretreatment solution.

| | | |
|---|---|---|
| FeCl₃/ | Content in | |
| BMIMCl/water (%) | solid residue (%) | Digestibility |

| and pretreatment time | Glucan | Xylan | (%) |
|---|---|---|---|
| 0.6/89.4/10.0, 60 min | 60.7 | 5.2 | 90.1 |
| 0.6/79.4/20.0, 60 min | 61.2 | 10.8 | 60.4 |
| 1.2/78.4/20.0, 30 min | 63.1 | 8.3 | 86.0 |
| 1.8/88.2/10.0, 30 min | 63.8 | 4.6 | 95.3 |
| 1.8/88.2/10.0, 60 min | 66.8 | 4.0 | 100.0 |
| 1.8/78.2/20.0, 60 min | 65.7 | 6.6 | 97.6 |
| 1.8/98.2/0.0, 120 min | 53.6 | 9.7 | 42.9 |
| Untreated bagasse | 42.9 | 22.8 | 6.9 |

### Example 9

### Pretreatment of Bagasse with Pretreatment Solutions Comprising Mineral Halides

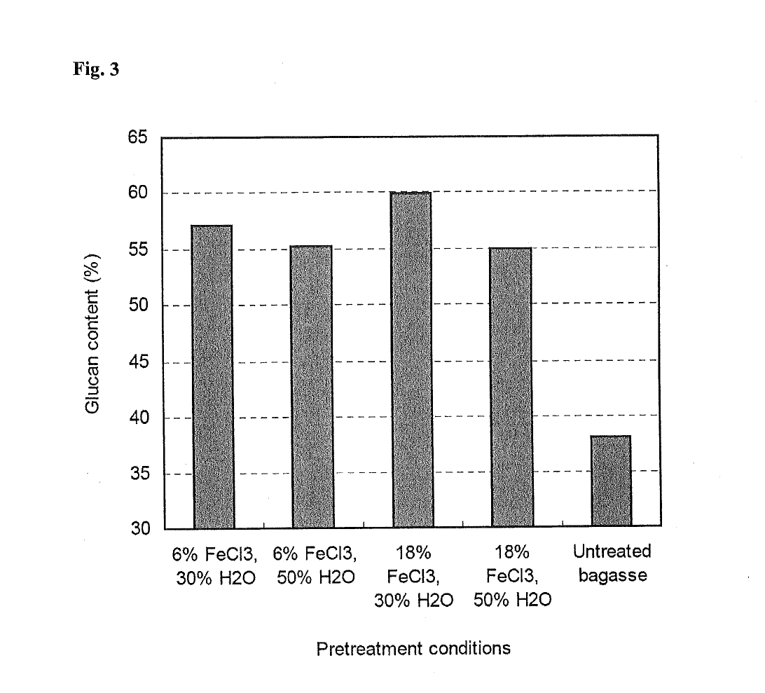

Sugar cane bagasse was pretreated with a pretreatment solution comprising FeCl₃ and water at 130° C. for 2 hours. The concentration of FeCl₃ in the pretreatment solution was based on the weight of dry bagasse and was either 6% or 18%. The water content during the pretreatment step was either 30% or 50%. The glucan content (%) after pretreatment is shown in FIG. 3.

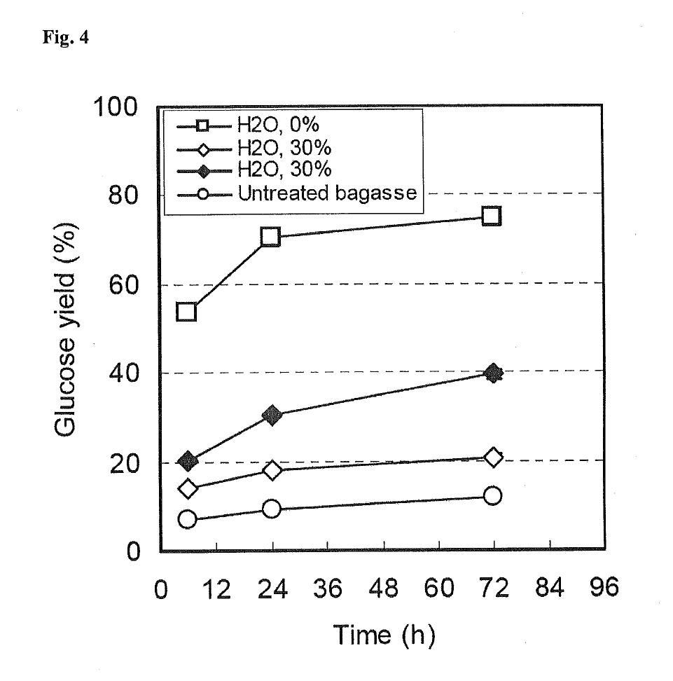

Sugar cane bagasse was pretreated with a pretreatment solution comprising FeCl₃ and water at 80° C. for 24 hours. The concentration of FeCl₃ in the pretreatment solution was based on the weight of dry bagasse and was either 6% or 18%. The water content during the pretreatment step was either 0% or 30%. After pretreatment, water was added to the pretreated bagasse to wash the solid residue. The solid residue was then separated from the pretreatment solution. The solid residue was then enzymatically hydrolyzed to produce fermentable sugars. The glucose yield (%) at different times during the enzymatic hydrolysis is shown in FIG. 4.

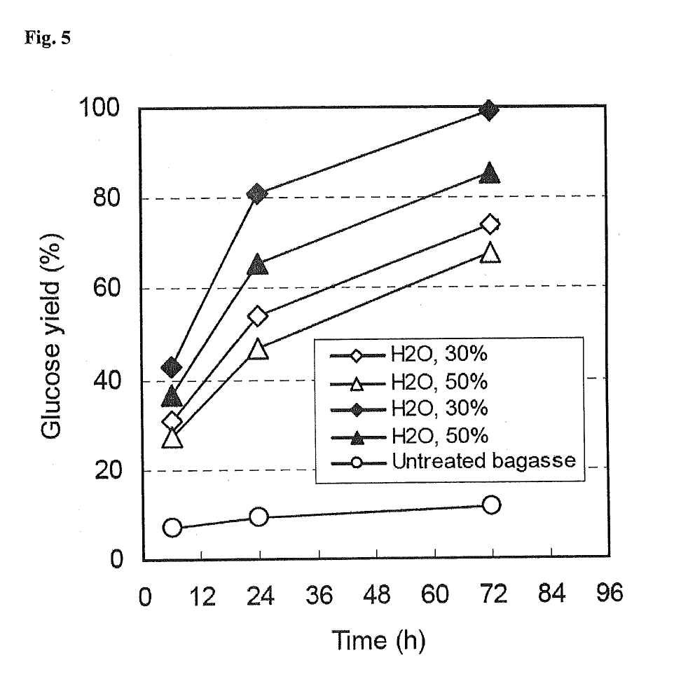

Sugar cane bagasse was pretreated with a pretreatment solution comprising FeCl₃ and water at 130° C. for 2 hours. The concentration of FeCl₃ in the pretreatment solution was based on the weight of dry bagasse and was either 6% or 18%. The water content during the pretreatment step was either 30% or 50%. After pretreatment, water was added to the pretreated bagasse to wash the solid residue. The solid residue was then separated from the pretreatment solution. The solid residue was then enzymatically hydrolyzed to produce fermentable sugars. The glucose yield (%) at different times during the enzymatic hydrolysis is shown in FIG. 5.

### Example 10

### Recycling of the Pretreatment Solution

A bagasse sample was pretreated with a fresh batch of a pretreatment solution comprising 78.8% BMIMCl, 1.2% HCl, and 20.0% water at 130° C. for 30 min. After pretreatment, the filtrate/hydrolysate was collected and water was removed by vacuum evaporation at 80° C. to produce a concentrated filtrate. Without adding any additional acid, the concentrated filtrate was adjusted to a water concentration of approximately 20% to produce a recycled pretreatment solution.

The recycled pretreatment solution was then used to pretreat another fresh bagasse sample (i.e., a second bagasse sample) at 130° C. for 30 min. After pretreatment, the filtrate was again collected and the same process was followed for recycling the pretreatment solution. The pretreatment solution was subsequently recycled two additional times and each recycled solution was used to pretreat another fresh bagasse sample (i.e., a third and fourth bagasse sample) at 130° C. for 30 min. After each pretreatment, the pretreated bagasse was collected, washed and filtered before enzymatic hydrolysis.

As shown in Table 7, the use of a recycled pretreatment solution resulted in high levels of enzyme digestibility. Thus, the pretreatment solutions can be used repeatedly, thereby increasing the efficiency of the process.

TABLE 7
Glucan digestibility of bagasse pretreated with recycled
BMIMCl/HCl/water pretreatment solutions.

| Pretreatment batch | Digestibility (%) |
|---|---|
| First (fresh solution) | 97.5 |
| Second | 98.0 |
| Third | 97.4 |
| Fourth | 97.3 |

### Example 11

### Two-Step Pretreatment

A two-step pretreatment process was performed to determine if the levels of inhibitors, such as acetic acid, HMF, and furfural, could be reduced. In the first step of the two-step pretreatment process, a 1.2% HCl solution was used to pretreat the bagasse (i.e., pre-pretreatment) at 130° C. for 60 min. As can be seen in Table 1, treatment with 1.2% HCl removes most of the xylan and the acetyl groups (a precursor for acetic acid) from the pre-pretreated bagasse.

In the second step of the two-step pretreatment process, the pre-pretreated bagasse was treated with an ionic liquid/acid/water pretreatment solution at 130° C. for 30 minutes, as shown below in Table 8. As shown in Tables 2 and 8, after the two-step pretreatment, the acetic acid yield based on the dry weight of untreated bagasse was reduced significantly to 0.5%. The furfural yields based on the total xylan in untreated bagasse were also reduced significantly from 32.0% to 11.4% for bagasse pretreated with a BMIMCl pretreatment solution comprising 20% water and from 23.4% to 7.2% for bagasse pretreated with a BMIMCl pretreatment solution comprising 30% water.

Compared to a one-step pretreatment process, such as the pretreatment of bagasse with a pretreatment solution comprising 78.8% BMIMCl, 1.2% HCl, and 20.0% water as shown in Table 2, the two-step pretreatment significantly reduced the concentrations of acetic acid and furfural in the hydrolysate (Table 8).

TABLE 8
Composition of the hydrolysate after the two-step pretreatment process.

| | | | | | | Yield based | | Yield based | |
|---|---|---|---|---|---|---|---|---|---|
| | | | | | | on the | | on the | |
| | Yield based on the dry weight of untreated | | | | | total glucan | | total xylan | |
| Water/ | bagasse (%) | | | | | in untreated | | in untreated | |
| BMIMCl/ | | | | | Acetic | bagasse (%) | | bagasse (%) | |
| HCl (%) | Glucose | Xylose | HMF | Furfural | acid | Glucose | HMF | Xylose | Furfural |
| 20.0/78.8/12 | 0.9 | 1.0 | 0.4 | 1.9 | 0.5 | 1.9 | 1.2 | 3.9 | 11.4 |
| 30.0/68.8/1.2 | 1.0 | 2.6 | 0.1 | 1.2 | 0.5 | 2.1 | 0.3 | 10.0 | 7.2 |

The glucan digestibility of the pretreated bagasse after the second step of the two-step pretreatment process is shown in Table 9. Compared to the one-step pretreatment process as shown in Table 1, the two-step pretreatment process showed similar levels of glucan digestibility.

TABLE 9
Glucan digestibility after the second step of the two-step pretreatment
process.

Content in
solid residue (%)

| BMIMCl/HCl/Water | Glucan | Xylan | Digestibility (%) |
|---|---|---|---|
| 78.8/1.2/20.0 | 68.4 | 2.1 | 95.0 |
| 68.8/1.2/30.0 | 65.9 | 3.3 | 93.7 |

### Example 12

### Delignification after Pretreatment

4.30 grams of dry bagasse were pretreated with 40.0 grams of a pretreatment solution comprising 78.8% BMIMCl, 1.2% HCl, and 20% water at 130° C. for 30 min. After pretreatment, the pretreated bagasse was washed with 400 mL of water four times and then washed four times with 100 mL of a basic solution comprising 0.2% NaOH (0.005 M, pH 12.3) at room temperature (about 24° C.).

After being washed with the basic solution, the glucan content in the solid residue was improved to over 80% compared to pretreated bagasse not washed with a basic solution (Table 10). For the bagasse washed with the basic solution, the lignin content was reduced to less than 10% (Table 10).

TABLE 10
Effect of dilute soda (0.2% NaOH solution) washing
on cellulose, xylan and lignin content and recovery.

| | Content in solid | | | Recovery in solid | | |
|---|---|---|---|---|---|---|
| | residue (%) | | | residue (%) | | |
| Conditions | Glncan | Xylan | Lignin | Glucan | Xylan | Lignin |
| Before wash | 69.6 | 1.9 | 25.9 | 92.8 | 4.8 | 54.9 |
| After wash | 90.3 | 2.3 | 5.7 | 92.0 | 4.4 | 9.2 |

The pretreated bagasse samples that were either washed with a basic solution (i.e., the “washed” bagasse sample), as described above, or not washed with a basic solution (i.e., the “unwashed” bagasse sample), were subsequently digested with varying amounts of cellulase (Accellerase® 1000). As shown in Table 11, at a cellulase loading of 0.33-0.50 mL/g cellulose the glucan digestibilities of the washed bagasse samples at 12 hours were 15.8-23.3% higher than those of the unwashed solid residues. The 72 h glucan digestibilities of the washed solid residues were slightly higher than those of unwashed samples,

TABLE 11
Glucan digestibility of unwashed and washed bagasse samples.

| | 12 h digestibility (%) | | | 72 h digestibility (%) | | |
|---|---|---|---|---|---|---|
| | Un- | | | Un- | | |
| | washed | Washed | Improvement | washed | Washed | Improvement |
| 0.50 | 80.2 | 96.0 | 15.8 | 97.5 | 98.9 | 1.4 |
| 0.33 | 69.4 | 90.1 | 20.7 | 96.8 | 97.8 | 1.0 |
| 1.67 | 42.7 | 66.0 | 23.3 | 92.4 | 96.0 | 3.6 |

### Example 13

### Pretreatment of Bagasse with a Pretreatment Solution Comprising EMIMCl

Pretreatment of bagasse at varying temperatures for 30 minutes with pretreatment solutions comprising EMIMCl and HCl at varying concentrations was examined. As shown in Table 12, each of the pretreatment solutions contained 20% water, Bagasse pretreated with a pretreatment solution comprising 78.8% EMIMCl, 20% water, and 1.2% HCl at 130° C. for 30 minutes resulted in 71.6% glucan and 0.9% xylan being obtained in the solid residue and achieved complete (100%) digestibility after a 72 hour enzymatic digestion.

TABLE 12
Pretreatment of bagasse using EMIMCl/HCl/Water pretreatment solutions

| | Content in | | |
|---|---|---|---|
| | solid residue (%) | | |
| EMIMCl/HCl/Water | Glucan | Xylan | Digestibility (%) |
| 78.8/1.2/20.0, 90° C., 30 min | 57.9 | 12.6 | 31.5 |
| 79.6/0.4/20.0, 130° C., 30 min | 65.2 | 3.7 | 93.5 |
| 78.8/1.2/20.0, 130° C., 30 min | 71.6 | 0.9 | 100.0 |
| Untreated bagasse | 42.9 | 22.8 | 6.9 |

### Example 14

### Pretreatment of Bagasse with a Pretreatment Solution Comprising BMIMCH₃SO₃

Pretreatment of bagasse at varying temperatures for 30 or 60 minutes with pretreatment solutions comprising BMIMCH₃SO₃ at varying concentrations with and without an acid catalyst was examined. As shown in Table 13, bagasse pretreated at 130° C. for 30 minutes with a pretreatment solution comprising 78.8% BMIMCH₃SO₃, 1.2% HCl, and 20% water resulted in a solid residue having 80.1% glucan and 5.9% xylan and a 96.6% digestibility after a 72 hour enzymatic hydrolysis. Bagasse pretreated at 130° C. for 60 minutes with a pretreatment solution comprising 80.0% BMIMCH₃SO₃, 20% water, and no acid catalyst resulted in a solid residue having 80.3% glucan and 5.8% xylan and a 98.6% digestibility after a 72 hour enzymatic hydrolysis. In contrast, pretreatment of bagasse at 110° C. for 60 minutes with a pretreatment solution comprising 80.0% BMIMCH₃SO₃, 20%, water, and no acid catalyst resulted in a much reduced digestibility (38.6%).

TABLE 13
Pretreatment of bagasse with pretreatment solutions comprising
BMIMCH₃SO₃

| | Content in | | |
|---|---|---|---|
| | solid residue (%) | | |
| BMIMCH₃SO₃/HCl/Water | Glucan | Xylan | Digestibility (%) |
| 78.8/1.2/20.0, 130° C., 30 min | 80.1 | 5.9 | 96.6 |
| 80.0/0.0/20.0, 130° C., 60 min | 80.3 | 5.8 | 98.6 |
| 80.0/0.0/20.0, 110° C., 60 min | 71.7 | 11.9 | 38.6 |
| 80.0/0.0/20.0, 90° C., 60 min | 58.1 | 17.6 | 13.5 |
| Untreated bagasse | 42.9 | 22.8 | 6.9 |

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

1. A method for producing a partially hydrolyzed lignocellulosic material, comprising pretreating a lignocellulosic material with a pretreatment solution comprising about 40% to about 95% by weight an ionic liquid and about 5% to about 60% by weight water, thereby producing a pretreated partially hydrolyzed lignocellulosic material.

2. The method of claim 1, wherein the pretreatment solution further comprises about 0.1% to about 5% by weight an acid catalyst.

3. The method of claim 1, wherein the pretreating step is carried out at a temperature from about 80° C. to about 150° C.

4.-7. (canceled)

8. The method of claim 1, wherein the ionic liquid comprises an imidazolium cation.

9. The method of claim 1, wherein the ionic liquid comprises an anion selected from the group consisting of a halide anion, an acetate anion, a methanesulfonate anion, a tosylate anion, or any combination thereof.

10.-12. (canceled)

13. The method of claim 2, wherein the acid catalyst is present in an amount of about 0.5% to about 2% by weight of the pretreatment solution.

14. The method of claim 1, wherein the ionic liquid is present in an amount of about 70% to about 85% by weight of the pretreatment solution.

15. The method of claim 1, wherein water is present in an amount of about 15% to about 25% by weight of the pretreatment solution.

16. The method of claim 1, wherein the partially hydrolyzed lignocellulosic material has a total recovered lignin content of at least 40% of the total lignin in the lignocellulosic material prior to the pretreating step.

17. The method of claim 1, wherein the pretreating step decreases the amount of hemicellulose in the lignocellulosic material by at least 40%.

18. The method of claim 1, wherein the pretreating step reduces the production of 5-hydroxymethylfurfural, furfural, and/or acetic acid.

19. The method of claim 1, further comprising separating the pretreated lignocellulosic material from the pretreatment solution and collecting the pretreatment solution, thereby producing a recycled pretreatment solution.

20. The method of claim 1, further comprising washing the pretreated lignocellulosic material with a basic solution.

21. (canceled)

22. The method of claim 20, wherein the pretreating and washing step remove about 65% of the lignin present in the lignocellulosic material prior to the pretreating step.

23. (canceled)

24. The method of claim 19, further comprising treating a lignocellulosic material with the recycled pretreatment solution.

25. The method of claim 24, further comprising heating the pretreated lignocellulosic material to a temperature from about 40° C. to about 150° C. for about 30 minutes to about 72 hours.

26. The method of claim 1, further comprising enzymatically hydrolyzing the pretreated lignocellulosic material to produce a fermentable sugar.

27. The method of claim 26, wherein enzymatic digestibility of the pretreated lignocellulosic material is increased by at least two times compared to untreated lignocellulosic material.

28. (canceled)

29. The method of claim 26, wherein the enzymatic hydrolysis step is carried out with plant produced enzymes that are produced by the lignocellulosic material.

30.-31. (canceled)

32. The method of claim 1, wherein prior to the pretreating step the lignocellulosic material is treated with an acid solution at a temperature from about 80° C. to about 200° C., wherein the acid is present in an amount of about 0.1% to about 5.0% by weight of the acid solution.
